(19) United States
(12) Patent Application Publication
(10) Pub. No.: US 2009/0280977 A1
(43) Pub. Date: Nov. 12, 2009

(54) PROCESS FOR PREPARING CATALYST COMPONENTS FOR THE POLYMERIZATION OF OLEFINS

(75) Inventors: Masaki Fushimi, Eschborn (DE); Maria Schmitt, Burgberg i.A. (DE); Martin Schneider, Kelkheim (DE); Giampiero Morini, Padova (IT)

Correspondence Address: LyondellBasell Industries, 3801 WEST CHESTER PIKE, NEWTOWN SQUARE, PA, 19073, US

(73) Assignee: Basell Poliolefine Italia s.r.l, Milano (IT)

(21) Appl. No.: 12/309,983

(22) PCT Filed: Aug. 10, 2007
(86) PCT No.: PCT/EP2007/007089

§ 371 Date: Feb. 5, 2009

Related U.S. Application Data
(60) Provisional application No. 60/841,293, filed on Aug. 30, 2006.

(30) Foreign Application Priority Data
Aug. 15, 2006 (EP) 06016981.0

(51) Int. Cl. B01J 31/04; B01J 31/02; B01J 31/38

(52) U.S. Cl. 502/158; 502/170; 502/169

(57) ABSTRACT

The instant invention relates to a process for preparing a catalyst component for the polymerization of olefins. Catalysts prepared with this catalyst component provide a high mileage for the production of polyolefin with a high bulk density of the polymer produced therewith. Particularly, catalysts prepared with this catalyst component are suitable for the improved economical production of polyolefin in gas phase processes.

The present invention relates to a process for preparing components for a catalyst for the polymerization of olefins under low pressure conditions. Such catalyst is known in the art and described there as a Ziegler Catalyst. The catalyst components comprise a carrier component and a titanium compound; the carrier compound is produced from magnesium metal, organic acid ester compound, organic halide and inorganic metal oxide. The catalyst component is suitable to be converted by contacting co-catalyst into a catalyst system. Catalyst systems prepared with catalyst component of this invention provide a high mileage or productivity for the production of polyolefin with a high bulk density of the polymer produced therewith. Particularly, the catalyst system prepared with the catalyst component of this invention is suitable for improved economical production of polyolefin by gas phase processes.

Polymerization catalysts which exhibit high productivity are well known. Polymerization catalysts which provide polymers with high bulk density are also known in many prior art references.

U.S. Pat. No. 4,220,554 describes catalyst components for polymerization. In that article, the catalyst are obtained by reacting magnesium metal and an organic halide RX, in which X is a halogen and R is a hydrocarbon radical, together with silicic acid esters having the formula, XₘSi (OR)₄₋ₘ, wherein R is hydrocarbon radical, X is halogen or an alkyl, aryl or cycloalkyl radical containing 1 to 20 carbon and m is a number from 0 to 3. Then it is reacted with a large excess amount of TiCl₄ in the presence of internal donor. Although the resulting catalyst shows the satisfactory performance for the stereospecific propylene catalyst, it is difficult to produce, in satisfactory mileage, for ethylene polymerization with high polymer bulk density.

U.S. Pat. No. 7,015,169 discloses a process for preparing catalyst systems of the Ziegler-Natta type, which comprises an inorganic metal oxide such as silica, magnesium compound, halogenating reagent, an alcohol and a tetravalent titanium compound. The catalyst provides a polymer with high bulk density, but the productivity remains in unsatisfactory level, if the catalyst is used in a gas phase process.

It is therefore still the need of a catalyst component suitable to form a catalyst system showing a good balance of polymer productivity, a production of polymers with high bulk density, particularly for the commercial production in gas phase process.

The inventors have surprisingly found a process for preparing catalyst component satisfying the above-mentioned needs. Such process comprises the chemical reaction of a carrier compound with a titanium compound, wherein the carrier compound is produced by reacting metallic magnesium with an organic acid ester compound, organic halide and an inorganic metal oxide, which inorganic metal oxide having an average particle size in the range of from 0.1 to 100 micrometer (μm).

The catalyst component then can be converted to an olefin polymerization catalyst system by contacting the catalyst component with a co-catalyst and optionally with a specific type of donor compound, in which a process for the polymerization or copolymerization of olefins is operated at a temperature in the range of from 20 to 150° C. under a pressure in the range of from 1 up to 100 bars (0.1 to 10 MPa) under gas phase conditions.

The preparation of the carrier compound along with the instant invention is based on Grignard reaction and can be applied according to the conventional methods.

Metallic magnesium of any suitable size is employable herein, including, for example, granular, ribbon-like and powdery metal magnesium.

The surface condition of the metal magnesium is not specifically defined, but metal magnesium not coated with a film of magnesium hydroxide is preferred for use herein.

The organic acid ester compound can be selected from silicic acid esters having the formula, XₘSi(OR)₄₋ₘ, or carbon acid esters having RₘC(OR)₄₋ₘ, where R is an alkyl, aryl or cycloalkyl radical containing 1 to 20 carbon, X is halogen or hydrogen or an alkyl, aryl or cycloalkyl radical containing 1 to 20 carbon and m is an integer from 0 to 3.

Specific examples of silicic acid esters are Si(OMe)₄, Si(OEt)₄, Si(O(n-Prop))₄, Si(O(iso-Prop))₄, Si(O(n-Bu))₄, Si(OPh)₄, MeSi(OMe)₃, Me₂Si(OMe)₂, MeSi(OEt)₃, Me₂Si(OEt)₂, EtSi(OMe)₃, Et₂Si(OMe)₂, EtSi(OEt)₃, Et₂Si(OEt)₂, ClSi(OMe)₃, ClSi(OEt)₃, HSi(OMe)₃ and HSi(OEt)₃.

Specific examples of organic acid esters are C(OMe)₄, C(OEt)₄, HC(OMe)₃, HC(OEt)₃, C(O(n-Prop))₄, C(O(n-Bu))₄, C(OPh)₄, MeC(OMe)₃, Me₂C(OMe)₂, EtC(OMe)₃.

The preferred organic acid esters are Si(OEt)₄, HC(OEt)₃ and C(OEt)₄.

The organic acid ester compound is generally employed in an amount such that the ratio between OR groups and gram atoms of Mg is higher than 1 and preferably comprised between 3:1 and 20:1.

The organic halide, RX, in which X is a halogen, preferable Cl or Br, R is an alkyl, alkenyl, aryl or cycloalkyl radical having 1 to 20 carbon atoms, preferable 1 to 8 carbon atoms, are employed as organic halides. Such compounds are, for example, methyl-, ethyl-, propyl-, iso-propyl-, n-butyl-, iso-butyl-, sec-butyl-, tert-butyl-, n-amyl-, n-hexyl-, n-heptyl-, n-octyl-, cyclopentyl-, and cyclohexyl chlorides and bromides, chlorobenzene, o-chlorotoluene, 2-chloroethylbenzene, vinyl chloride and benzyl chloride.

The RX compound is generally employed in an amount such that the ratio between X groups and gram atoms of Mg is equal to or higher than 1 and preferably comprised between 5:1 and 1.1:1. In a presently preferred embodiment, 1 to 2 moles of organic halide per gram atom of Mg are used.

An inorganic metal oxide which is suitable for this invention is, for example, silica gel, aluminum oxide, hydrotalcite, mesoporous materials and aluminosilicate, in particular silica gel is preferred.

The inorganic metal oxide can also be partially or fully modified prior to the reaction. The inorganic metal oxide can, for example, be treated under oxidizing or non-oxidizing conditions at temperatures in the range of from 100° C. to 1000° C., in the presence or absence of fluorinating agents such as ammonium hexafluorosilicate. The water and/or OH group content can be varied in this way. The inorganic metal oxide is preferably dried under reduced pressure over a time period of from 1 to 10 hours at 100 to 800° C., preferably 150 to 650° C., before use in the process of the invention. If the inorganic metal oxide is silica, this is not reacted with an organosilane prior to use.

In general, the inorganic metal oxide has a mean particle diameter of from 0.01 to 100 μm, preferably from 0.1 to 90 μm and particularly preferably from 0.5 to 70 μm, an average pore volume of from 0.1 to 10 ml/g, in particular from 0.8 to 4.0 ml/g and particularly preferably from 0.8 to 2.5 ml/g, and a specific surface area of from 10 to 1000 m²/g, in particular from 50 to 900 m²/g, particularly preferably from 100 to 600 m²/g. The inorganic metal oxide can be shaped spherically or granularly and it is preferably spherical.

The specific surface area and the mean pore volume are determined by nitrogen adsorption using the BET method as described, for example, in S. Brunauer, P. Emmett and E. Teller in Journal of the American Chemical Society, 60, (1939), pages 209 to 319.

In another preferred embodiment of the instant invention, spray-dried silica gel is used as inorganic metal oxide. In general, the primary particles of the spray-dried silica gel have a mean particle diameter of from 0.1 to 10 μm, in particular from 0.5 to 5 μm. The primary particles are porous, granular, silica gel particles which are obtained by milling, if desired after appropriate sieving, of an SiO₂ hydrogel. The spray-dried silica gel can then be prepared by spray drying of the primary particles which have been slurried with water or an aliphatic alcohol.

The inorganic metal oxide is generally employed in an amount such that the ratio between the weight of inorganic metal oxide and the weight of Mg is 0.1 to 300 wt %, preferably 1 to 200 wt %.

The reaction is carried out at temperatures ranging from 20 to 250° C., preferably from 50 to 150° C. The order in which the reagents are added is not critical.

However, it is preferable to add organic halide into the mixture of magnesium metal, inorganic metal oxide and organic acid ester compound.

It is possible to utilize the reaction with polar solvent such as dimethylether, dibutylether, tertahydrofurane (THF), dimethyl sulfoxide (DMSO) and similar solvents, and the mixture with hydrocarbons, for examples, toluene/n-butylether and so on.

The reaction may be also carried out in the presence of an inert diluents such as for example, an aliphatic, cycloaliphatic or aromatic hydrocarbon, namely hexane, heptane, benzene, toluene and so on.

Iodine, alkyl iodine, or inorganic halides such as CaCl₂, CuCl, AgCl, and MnCl₂, halogenated hydrocarbons such as chloroethane, bromoethane, 1,2-dibromoethane and so on may be used as reaction promoters.

On the other hand, it is also effective to heat magnesium metal under argon or nitrogen flow, or under reduced pressure for a time period of from 30 min to 5 hours in order to take off the water around the magnesium metal.

After the completing the reaction, it is preferable to wash the resulting solid with hydrocarbon such as hexane or heptane over several washing steps.

The catalyst component is obtained by reacting the carrier compound with a titanium compound. Examples of suitable titanium compounds which can be used in the present invention include titanium halides such as titanium tetrachloride and titanium trichloride; titanium alkoxides such as titanium butoxide and titanium ethoxide; aryloxytitanium halides such as phenoxytitanium chloride; and the like. Mixtures of two or more of these titanium compounds may also be used.

The reaction temperature is not critical and can range from −20 to 150° C., preferable in the range of from 0 to 135° C.

Although the reaction is able to be conducted using the liquid titanium compound as reaction medium, it is preferred carrying out the reaction in an inert medium, that is liquid at least at the reaction temperature. Preferred inert medium are liquid aliphatic or aromatic hydrocarbons, optional chlorinated, and among them those having from 3 to 20 carbon atoms. Especially preferred are propane, n-butane, n-pentane, n-hexane, n-heptance, benzene, toluene and isomeres thereof. A mix of two or more of said hydrocarbons can also be used.

Electron donor compounds can also be applied during or after the reaction of the carrier compound and the titanium compound optionally. As electron donors, there can be used oxygen-containing compounds, nitrogen-containing compounds and the like.

More specifically, there can be used as donor compounds:

(1) alcohols having 1 to 20 carbon atoms, such as methanol, ethanol, propanol, butanol, heptanol, hexanol, octanol, dodecanol, octadecyl alcohol, 2-ethylhexyl alcohol, benzyl alcohol, cumyl alcohol, diphenylmethanol, triphenylmethanol, and the like;
(2) phenols having 6 to 25 carbon atoms which may have an alkyl group on the benzene ring, such as phenol, cresol, ethylphenol, propylphenol, cumylphenol, nonylphenol, naphthol, and the like;
(3) ketones having 3 to 15 carbon atoms, such as acetone, methyl ethyl ketone, methyl isobutyl ketone, acetophenone, cyclohexanone, and the like;
(4) aldehydes having 2 to 15 carbon atoms, such as acetaldehyde, propionaldehyde, tolualdehyde, naphthoaldehyde, and the like;
(5) organic acid esters having 2 to 20 carbon atoms, such as methyl formate, ethyl formate, methyl acetate, ethyl acetate, propyl acetate, octyl acetate, cyclohexyl acetate, methylcellosolve acetate, cellosolve acetate, ethyl propionate, methyl n-butyrate, methyl isobutyrate, ethyl isobutyrate, isopropyl isobutyrate, ethyl valerate, butyl valerate, ethyl stearate, methyl chloroacetate, ethyl dichloroacetate, methyl methacrylate, ethyl methacrylate, ethyl crotonate, ethyl cyclohexanecarboxylate, methyl phenylacetate, methyl phenylbutyrate, propyl phenylbutyrate, methyl benzoate, ethyl benzoate, propyl benzoate, butyl benzoate, octyl benzoate, cyclohexyl benzoate, phenyl benzoate, benzyl benzoate, cellosolve benzoate, methyl toluoylate, ethyl toluoylate, amyl toluoylate, ethyl ethylbenzoate, methyl anisate, ethyl anisate, ethyl ethoxybenzoate, diethyl phthalate, diisobutyl phthalate, diheptyl phthalate, dineopentyl phthalate, gamma.-butyrolactone, gamma-valerolactone, cumarine, phthalide, diethyl carbonate, methyl orthoformate, succinates and the like;
(6) alkoxy esters, such as methyl methoxyacetate, ethyl methoxyacetate, butyl methoxyacetate, phenyl methoxyacetate, methyl ethoxyacetate, ethyl ethoxyacetate, butyl ethoxyacetate, phenyl ethoxyacetate, ethyl n-propoxyacetate, ethyl i-propoxyacetate, methyl n-butoxyacetate, ethyl i-butoxyacetate, ethyl n-hexyloxyacetate, octyl sec-hexyloxyacetate, methyl 2-methylcyclohexyloxyacetate, methyl 3-methoxypropionate, ethyl 3-methoxypropionate, butyl 3-methoxypropionate, ethyl 3-ethoxypropionate, butyl 3-ethoxypropionate, n-octyl 3-ethoxypropionate, dodecyl 3-ethoxypropionate, pentamethylphenyl 3-ethoxypropionate, ethyl 3-(i-propoxy)propionate, butyl 3-(i-propoxy)propionate, allyl 3-(n-propoxy)propionate, cyclohexyl 3-(n-butoxy)propionate, ethyl 3-neopentyloxypropionate, butyl 3-n-octyloxy)propionate, octyl 3-(2,6-dimethyldecyloxy)propionate, ethyl 4-ethoxybutyrate, cyclohexyl 4-ethoxybutyrate, octyl 5-(n-propoxy)valerate, ethyl 12-ethoxylaurate, ethyl 3-(1-indenoxy)propionate, methyl 3-methoxyacrylate, methyl 2-ethoxyacrylate, ethyl 3-phenoxyacrylate, ethyl 2-methoxypropionate, n-butyl 2i-propoxy)butyrate, methyl 2-ethoxyisobutyrate, phenyl 2-cyclohexyloxyisovalerate, butyl 2-ethoxy-2-phenylacetate, allyl 3-neopentyloxybutyrate, methyl 3-ethoxy-3-(o-methylphenyl)propionate, ethyl 3-ethoxy-2-(o-methylphenyl)propionate, ethyl 4-ethoxy-2-methyl-1-naphthylnonanoate, ethyl 2-methoxycyclopentanecarboxylate, butyl 2-ethoxycyclohexanecarboxylate, isopropyl 3-(ethoxymethyl)tetralin-2-acetate, ethyl 8-butoxydecaline-1-carboxylate, methyl 3-ethoxynorbornane-2-carboxylate, methyl 2-(phenoxy)acetate, ethyl 3-(p-cresoxy)propionate, methyl 4-(2-naphthoxy)butyrate, butyl 5-carbazoloxyvalerate, methyl 2-phenoxypropionate, ethyl 3-(4-methylphenoxy)-2-phenylpropionate, ethyl 2-phenoxycyclohexanecarboxylate, ethyl thiophene-3-oxyacetate, ethyl 2-(2-picolinoxymethyl)cyclohexanecarboxylate, ethyl 3-furfuryloxypropionate, and the like;
(7) keto esters, such as methyl acetylacetate, ethyl acetylacetate, butyl acetylacetate, methyl propionylacetate, phenyl acetylacetate, methyl propionylacetate, ethyl propionylacetate, phenyl propionylacetate, butyl propionylacetate, ethyl butyrylacetate, ethyl i-butanoylacetate, ethyl pentanoylacetate, methyl 3-acetylpropionate, ethyl 3-acetylpropionate, butyl 3-acetylpropionate, ethyl 3-propionylpropionate, butyl 3-propionylpropionate, n-octyl 3-propionylpropionate, dodecyl 3-propionylpropionate, pentamethylphenyl 3-propionylpropionate, ethyl 3-(i-propionyl)propionate, butyl 3-(i-propionyl)propionate, allyl 3-(i-propionyl)propionate, cyclohexyl 3-(i-propionyl)propionate, ethyl 3-neopentanoylpropionate, butyl 3-n-laurylpropionate, methyl 3-(2,6-dimethylhexanoyl)propionate, ethyl 4-propionylbutyrate, cyclohexyl 4-propionylbutyrate, octyl 5-butyrylvalerate, ethyl 12-butyryllaurate, methyl 3-acetylacrylate, methyl 2-acetylacrylate, ethyl 3-benzoylpropionate, methyl 3-benzoylpropionate, ethyl 3-methylbenzoylpropionate, butyl 3-toluylbutyrate, ethyl o-benzoylbenzoate, ethyl m-benzoylbenzoate, ethyl p-benzoylbenzoate, butyl o-toluylbenzoate, ethyl o-toluylbenzoate, ethyl m-toluylbenzoate, ethyl p-toluylbenzoate, ethyl o-(2,4,6-trimethylbenzoyl)benzoate, ethyl m-(2,4,6-trimethylbenzoyl)benzoate, ethyl p-(2,4,6-trimethylbenzoyl)benzoate, ethyl o-ethylbenzoylbenzoate, ethyl o-acetylbenzoate, ethyl o-propionylbenzoate, ethyl o-laurylbenzoate, ethyl o-cylcohexanoylbenzoate, ethyl o-dodecylbenzoate, and the like;
(8) inorganic acid esters, such as methyl borate, butyl titanate, butyl phosphate, diethyl phosphite, di-(2-phenylphenyl)phosophorochloridate, and the like;
(9) ethers having 2 to 25 carbon atoms, such as dimethyl ether, diethyl ether, diisopropyl ether, dibutyl ether, diamyl ether, tetrahydrofuran, anisole, diphenyl ether, ethylene glycol diethyl ether, ethylene glycol diphenyl ether, 2,2-dimethoxypropane, 2-isopropyl-2-isopentyl-1,3-dimetoxypropane, 2,2-diisobutyl-1,3-dimethoxypropane and the like;
(10) acid amides having 2 to 20 carbon atoms, such as acetamide, benzamide, toluylamide, and the like;
(11) acid halides having 2 to 20 carbon atoms, such as acetyl chloride, benzoyl chloride, toluoyl chloride, anisolyl chloride, phthaloyl chloride, isophthaloyl chloride, and the like;
(12) acid anhydrides having 2 to 20 carbon atoms, such as acetic anhydride, phthalic anhydride, and the like;
(13) amines having 1 to 20 carbon atoms, such as monomethylamine, monoethylamine, diethylamine, tributylamine, piperidine, tribenzylamine, aniline, pyridine, picoline, tetramethylethylenediamine, and the like;
(14) nitriles having 2 to 20 carbon atoms, such as acetonitrile, benzonitrile, tolunitrile, and the like;
(15) thiols having 2 to 20 carbon atoms, such as ethyl thioalcohol, butyl thioalcohol, phenyl thiol, and the like;
(16) thioethers having 4 to 25 carbon atoms, such as diethyl thioether, diphenyl thioether, and the like;
(17) sulfates having 2 to 20 carbon atoms, such as dimethyl sulfate, diethyl sulfate, and the like;
(18) sulfonic acids having 2 to 20 carbon atoms, such as phenyl methyl sulfone, diphenyl sulfone, and the like;
(19) silicon-containing compounds having 2 to 24 carbon atoms, such as phenyltrimethoxysilane, phenyltriethoxysilane, phenyltributoxysilane, vinyltriethoxysilane, diphenyldiethoxysilane, phenyldimethylmethoxysilane, phenyldimethylethoxysilane, triphenylmethoxysilane, hexamethyldisiloxane, octamethyltrisiloxane, trimethylsilanol, phenyldimethylsilanol, triphenylsilanol, diphenylsilanediol, lower alkyl silicate (particularly, ethyl silicate), and the like.

Two or more of the electron-donating compounds can be used in combination. Of these, preferred are organic acid esters, phthalic acid esters, 1,3-diethers, succinates, alkoxyesters, and ketoesters.

The reaction temperature for the electron donor compound is from room temperature to 150° C., preferable from 50 to 100° C. The molar ratio between the electron donor compound and the titanium compound ranges from 0.2 to 2, preferably from 0.5 to 1.5.

The solid is separated from the reaction mixture and washed with an inert hydrocarbon diluent such as hexane, heptane, decane and so on to remove the last traces of the unreacted titanium compound.

The washing step is preferable followed by a drying step in which all or the most or at least some of the residual solvent is removed. The novel catalyst component obtained in this way can be completely dry or have a certain residual moisture content. However, the content of volative constituents should preferably be not more than 20% by weight, in particular not more than 10% by weight, based on the total weight of the catalyst component.

The solid catalyst component according to the present invention is converted into catalyst system for the polymerization of olefins by reacting it with organoaluminum compounds according to known methods.

In particular, for the polymerization of olefins CH₂═CHR, in which R is hydrogen or a hydrocarbyl radical with 1 to 12 carbon atoms, comprising the product of the reaction between:
(a) a solid catalyst component as described above,
(b) an alkylaluminum compound and, optionally,
(c) an external electron donor compound.

The alkyl aluminium compound can be preferably selected from the trialkyl aluminum compounds such as for example trimethaylaluminum (TMA), triethylaluminum (TEA), triisobutylaluminum (TIBA), tri-n-butylaluminum, tri-n-hexylaluminum, tri-n-octylaluminum. Also alkylaluminum halides and in particular alkylaluminum chlorides such as diethylaluminum chloride (DEAC), diisobutylaluminum chloride, aluminum sesquichloride and dimethylaluminum chloride (DMAC) can be sued. It is also possible to use, and in certain cases preferred, mixture of trialkylalunium's with alkylalunium halides. Among them mixtures between TEA and DEAC are particularly preferred.

The Al/Ti ratio in the catalyst system is generally between 10 to 1000. Al/Ti ratios lower than 10 can be used provided that no electron donor compound is used or is used in an amount less than 20% by moles with respect to alunium alkyl compound.

The external donor compound can be equal to or different from the electron donors used in the solid catalyst component.

Preferred examples of external donor compounds are: (tert-butyl)₂Si(OCH₃); (isopropyl)₂Si(OCH₃)₂; (sec-butyl)₂Si(OCH₃)₂; (cyclohexyl)(methyl)Si(OCH₃)₂; (cyclopentyl)₂Si(OCH₃)₂; (isobutyl)₂Si(OCH₃)₂; (tert-butyl)(methyl)Si(OCH₃)₂; (tert-hexyl)(methyl)Si(OCH₃)₂; (tert-butyl)(cyclopentyl)Si(OCH₃)₂; (tert-butyl)Si(OCH₃)₃; (tert-hexyl)Si(OCH₃)₃; (tert-hexyl)Si(OC₂H₅)₃; (tert-butyl)(2-methylpiperidyl)Si(OCH₃)₂; (tert-butyl)(3-methylpiperidyl)Si(OCH₃)₂; (tert-hexyl)(piperidyl)Si(OCH₃)₂; (tert-hexyl)(pyrrolidinyl)Si(OCH₃)₂; (methyl)(3,3,3-trifluoropropyl)Si(OCH₃)₂; (3,3,3-trifluoropropyl)₂Si(OCH₃)₂, THF, 2,2,6,6-tetramethylpiperidine.

The conditions for the polymerization of olefins with the catalysts according to this invention are conventional as known in the art.

The polymerization may be conducted in a liquid phase either in the presence or absence of an inert hydrocarbon solvent (hexane, haptane, exxsol and so on), or in a gas phase.

The above mentioned catalyst components can be fed separately into the reactor where, under the polymerization conditions, they can exploit their activity.

The so formed catalyst system can be used directly in the main polyerization process or alternatively, it can be pre-polymeizied beforehand. A pre-polymeization step is usually preferred when the main polymerization process is carried out in the gas phase. The prepolymeization can be carried out with any of the olefins CH₂═CHR, where R is H or a C₁ to C₁₀ hydrocarbon group. In particular, it is especially preferred to pre-polymerize ethylene or mixtures thereof with one or more alpha-olefins, said mixtures containing up to 20% in moles of alpha-olefin, forming amounts of polymer of from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred. Examples of gas phase process wherein it is possible to use the catalyst of the invention are described in WO 92/21706, U.S. Pat. No. 5,733,987 and WO 93/03079. These processes comprise a pre-contact step of the catalyst components, a pre-polymerization step and a gas phase polymeriation step in one or more reactors in a series of fluidized or mechanically stirred bed. In a particular embodiment, the gas phase process can be suitably carried out according to the following steps:
(i) pre-polymeirying with one or more olefins of formula CH₂═CHR, where R is H or a C₁ to C₁₀ hydrocarbon group, up to forming amounts of polymer from about 0.1 up to a maximum of about 1000 g per gram of solid catalyst component; and
(ii) polymerizing in the gas phase ethylene, or mixtures thereof with alpha-olenfins CH₂═CHR in which R is a hydrocarbon radical comprising 1 to 10 carbon atoms, in one or more fluidized or mechanically stirred bed reactors, in the presence of the product coming from (i).

Non limitative examples of other polymers that can be prepared with the catalyst of the invention are very low density and ultra low density polyethylenes (VLDPE and ULDPE, having a density lower than 0.92 g/cm³, to 0.880 g/cm³) consisting of copolymers of ethylene with one or more alpha-olefins having from 3 to 12 carbon atoms, having a mole content of units derived from ethylene of higher than 80%: high density ethylene polymers (HDPE, having a density higher than 0.94 g/cm³), comprising ethylene homopolymers and copolymers of ethylene with alpha-olefins having 3 to 12 carbon atoms: The following examples are given in order to further describe the present invention in a non-limiting manner.

### Characterization

The properties are determined according to the following methods;

Eta value: by means of an automatic Ubbelohde viscometer (Lauda PVS 1) using decalin as solvent at 130° C. (ISO 1628 at 130° C., 0.001 g/ml of decalin)

The bulk density (BD) [g/l] was determined in accordance with DIN 53468.

The determination of the molar mass distributions and the mean Mₙ, M_{w} and M_{w}/Mₙ derived therefrom was carried out by means of high-temperature gel permeation chromatography (GPC) using a method based on DIN 55672 under the following conditions: solvent: 1,2,4-trichlorobenzene, flow: 1 ml/min, temperature: 140° C., calibration using PE standards.

The average particle sizes (APS) were determined by a method based on ISOWD 13320 particle size analysis using a Malvern Mastersizer 2000 (small volume MS1) under an inert gas atmosphere.

The magnesium contents were determined on the samples digested in a mixture of concentrated nitric acid, phosphoric acid and sulfuric acid by means of an inductively coupled plasma atomic emission (ICP-AES) spectrometer from Spectro, Kleve, Germany, using the spectral lines at 277.982 nm for magnesium.

The titanium content was determined on the samples digested in a mixture of 25% strength sulfuric acid and 30% strength hydrogen peroxide using the spectral line at 470 nm.

The Cl content has been determined via potentiometric tritration.

### EXAMPLES

All solvents were deoxygenated, dried over molecular sieves before use. TEA is Triethyl aluminum.

### Example 1

### Preparation of Catalyst Component

Into a 500 cm³ three necked round flask, purged with Argon, 4.0 g of magnesium metal (0.17 mol, Aldrich, granule, for Grignard Synthesis) was introduced. Then the flask was heated at 250° C. under reduced pressured for 1 hour.

After it was cooled down to room temperature, 10.1 g of silica ES757 (INEOS, calcinated at 600° C., 6 hours, ASP=26 μm) and 35 ml of tetraethy orthosilicate (Aldrich, 0.18 mol) were charged, bringing the suspension to 60° C., and a catalytic amount of iodine was introduced as a promoter. A solution of 1-chlorobutane (Aldrich, 21.9 ml, 0.26 mol) and n-hexane (Merck, 50 ml) were added dropwise in 45 min. The temperature was kept at 70° C. by removing the heat evolved by the reaction. The reaction was then continued at 70° C. for 3 hours. Washing with n-hexane were carried out by decantation, employing an amount of 100 ml of n-hexane for each time, for 6 consecutive times.

The solid product was suspended in 150 ml of n-hexane, then a solution of TiCl₄ (Fluka, 19 ml, 0.058 mol) and n-hexane (30 ml) was dropwise added in 15 min and were reacted for 1 hour at 60° C.

After the completing of reaction, unreacted TiCl₄ solution was removed by filtration at 50° C. and the solid was then washed with n-hexane at 50° C. until the chlorine ion disappeared. The resulting solid product was dried at 60° C. under vacuum for 4 hours.

Analysis: Ti=7.2 wt %, Mg=14.0 wt %, Cl=50.8 wt %, APS=28 μm

### Example 2-3

The procedure as reported in Example 1 was repeated by changing the kind of silica in diameter as reported in table 1.

### Example 4-6

The procedure as reported in Example 1 was repeated by changing the amount of silica (ES757) as reported in table 1.

### Example 7

### Modification of Silica

Into a 1000 cm³ four necked round flask, purged with Argon, 33.8 g of silica (INEOS, ES757, calcinated at 600° C., 6 hours) was introduced. Then 300 ml of n-hexane and TiCl₄ (1.3 ml, 4.0 mmol) were charged at room temperature. The temperature was raised to 60° C. and continued the reaction for additional 2 hours. The suspension was cooled down to room temperature then washed with 200 ml of n-hexane for each time, for 3 consecutive times. The solid product was vacuum dried at 60° C. for 4 hours.

The following procedure reported in Example 1 was repeated by changing the chemical modification as reported in table 1.

### Example 8-11

The procedure reported in Example 7 was repeated in the following by changing the chemical for modification as reported in table 1.

HMDS: hexamethyldisilazane.
DEAC: Diethylaluminum chloride
BOMAG: Butyl, octyl magnesium

### Example 12

The procedure reported in Example 1 was repeated in the following using 55 ml of HC(OEt)₃ instead of 35 ml of tetraethyl orthosilica.

### Comparative Example 1

### Preparation of Catalyst Component

Into a 500 cm³ three necked round flask, purged with Argon, 4.0 g of magnesium metal (0.17 mol, Aldrich, granule, for Grignard Synthesis) was introduced. Then the flask was heated at 250° C. under reduced pressured for 1 hour.

After it was cooled down to room temperature, 35 ml of tetraethyl orthosilicate (Aldrich, 0.18 mol) were charged, bringing the suspension to 60° C., and a catalytic amount of iodine was introduced as a promoter. A solution of 1-chlorobutane (Aldrich, 21.9 ml, 0.26 mol) and n-hexane (Merck, 50 ml) were dropwise added in 45 min. The temperature was kept at 70° C. by removing the heat evolved by the reaction. The reaction was then continued at 70° C. for 3 hours. Washing with n-hexane were carried out by decantation, employing an amount of 100 ml of n-hexane for each time, for 6 consecutive times.

The solid product was suspended in 150 ml of n-hexane, then a solution of TiCl₄ (Fluka, 19 ml, 0.058 mol) and n-hexane (30 ml) was dropweised in 15 min. and were reacted for 1 hour at 60° C.

After the completing of reaction, unreacted TiCl₄ solution was removed by filtration at 50° C. and the solid was then washed with n-hexane at 50° C. until the chlorine ion disappeared. The resulting solid product was dried at 60° C. under vacuum for 4 hours.

Analysis: Ti=7.4 wt %, Mg=16.1 wt %, Cl=55.0 wt %, APS=12 μm

### Comparative Example 2

### Preparation of Catalyst Component

Into a 500 cm³ three necked round flask, purged with Argon, 4.0 g of magnesium metal (0.17 mol, Aldrich, granule, for Grignard Synthesis) was introduced. Then the flask was heated at 250° C. under reduced pressured for 1 hour.

After it was cooled down to room temperature, 10.1 g of silica ES70Y (INEOS, calcinated at 600° C., 6 hours, ASP=95 μm) and 35 ml of tetraethyl orthosilicate (Aldrich, 0.18 mol) were charged, bringing the suspension to 60° C., and a catalytic amount of iodine was introduced as a promoter. A solution of 1-chlorobutane (Aldrich, 21.9 ml, 0.26 mol) and n-hexane (Merck, 50 ml) were dropweised in 45 min. The temperature was kept at 70° C. by removing the heat evolved by the reaction. The reaction was then continued at 70° C. for 3 hours. Washing with n-hexane were carried out by decantation, employing an amount of 100 ml of n-hexane for each time, for 6 consecutive times.

The solid product was suspended in 150 ml of n-hexane, then a solution of TiCl₄ (Fluka, 19 ml, 0.058 mol) and n-hexane (30 ml) was dropwise added in 15 min and were reacted for 1 hour at 60° C.

After the completion of the reaction, unreacted TiCl₄ solution was removed by filtration at 50° C. and the solid was then washed with n-hexane at 50° C. until the chlorine ion disappeared. The resulting solid product was dried at 60° C. under vacuum for 4 hours.

Analysis: Ti=7.0 wt %, Mg=12.8 wt %, Cl=48.0 wt %, APS=broad peak from 20 to 120 μm

### Polymerization of Ethylene: General Procedure.

A 1.5 L stainless-steel autoclave equipped with a stirrer, temperature and pressure indicator, feeding line for hexane, ethylene, and hydrogen, was used and purified by fluxing pure nitrogen at 70° C. for 60 minutes. Then, 500 cm³ of hexane containing 1.6 cm³ of 10% by wt/vol TEA/hexane solution, was introduced at a temperature of 30° C. under nitrogen flow. In a separate 200 cm³ round bottom glass bottle were successively introduced, 20 cm³ of anhydrous hexane, 0.33 cm³ of 10% by wt/vol, TEA/hexane solution and about 0.010˜0.030 g of the solid catalyst. They were mixed together, aged 10 minutes at room temperature and introduced under nitrogen flow into the reactor. The autoclave was closed, then the temperature was raised to 85° C., hydrogen (3.0 bars partial pressure) and ethylene (7.0 bars partial pressure) were added.

Under continuous stirring, the total pressure was maintained at 85° C. for 120 minutes by feeding ethylene. At the end of the reactor was depressurised and the temperature was dropped to 30° C. The recovered polymer was dried at 70° C. under reduced pressure.

The amount of recovered polyethylene and the polymer characteristics are reported in table 1.

### Polymerization of Ethylene Copolymer:

A 1.5 L stainless-steel autoclave equipped with a stirrer, temperature and pressure indicator, feeding line for ethylene, 1-butene and hydrogen, and a steel vial for the injection of the catalyst, was purified by fluxing pure nitrogen at 70° C. for 60 minutes. It was then washed with iso-butane, heated to 75° C. and finally loaded with 600 ml of iso-butane, 125 ml of 1-butene, ethylene (7.0 bars, partial pressure) and hydrogen (3.0 bars partial pressure).

In a 50 cm³ three neck glass flask were introduced in the following order, 27 cm³ of anhydrous hexane, 4 mmol of TEA in hexane solution and 4.7 mg of solid catalyst prepared pursuant Example 1. They were mixed together and stirred at room temperature for 5 minutes and thereafter introduced in the reactor through the steel vial by using a nitrogen overpressure.

Under continuous stirring, the total pressure was maintained constant at 75° C. for 120 minutes by feeding ethylene. At the end of that time period the reactor was depressurized and the temperature was dropped to 30° C. The recovered polymer was dried at 70° C. under vacuum and weighted. The polymer yield was 22.8 g and the polymer bulk density was 220 g/l, eta value was 1.77 g and M_{w}/Mₙ was 4.88.

TABLE 1

| | | | | Metal | | | | | | | |
|---|---|---|---|---|---|---|---|---|---|---|---|
| | | | | oxide | | | | | | | Polymer |
| | Type of | ASP | | charged | Ti | Mg | Cl | Yield | Productivity | Eta | bulk density |
| Ex. No. | Metal oxide | (μm) | Modifier | % | (%) | (%) | (%) | (g) | (g/g cat) | (dl/g) | (g/l) |
| Exp. 1 | ES757 | 26 | — | 10.0 | 7.2 | 14.0 | 50.8 | 109.0 | 4000 | 1.25 | 284 |
| Exp. 2 | Calbosil | 1.0 | — | 10.0 | 7.1 | 14.0 | 49.7 | 75.0 | 5200 | 1.15 | 250 |
| Exp. 3 | ES70X | 56 | — | 10.0 | 6.9 | 13.9 | 50.6 | 69.0 | 2100 | 1.25 | 253 |
| Exp. 4 | ES 757 | 25 | — | 40.0 | 5.2 | 11.1 | 41.1 | 92.0 | 2800 | 1.30 | 243 |
| Exp. 5 | ES 757 | 25 | — | 60.0 | 5.7 | 11.0 | 41.0 | 95.0 | 3300 | 1.30 | 289 |
| Exp. 6 | ES 757 | 25 | — | 100.0 | 4.0 | 8.3 | 29.8 | 60.0 | 1800 | 1.27 | 295 |
| Exp. 7 | ES 757 | 26.0 | HMDS | 60.0 | 5.2 | 11.3 | 39.7 | 80.0 | 3300 | 1.11 | 237 |
| Exp. 8 | ES 757 | 26.0 | TEA | 60.0 | 5.5 | 11.4 | 40.1 | 80.0 | 4000 | 1.07 | 224 |
| Exp. 9 | ES 757 | 26.0 | DEAC | 60.0 | 5.4 | 10.7 | 39.2 | 82.0 | 4900 | 1.10 | 297 |
| Exp. 10 | ES 757 | 26.0 | BOMAG | 60.0 | 5.6 | 11.3 | 40.5 | 59.0 | 3300 | 1.14 | 294 |
| Exp. 11 | ES 757 | 26.0 | TiCl₄ | 60.0 | 3.3 | 10.1 | 32.6 | 74.0 | 3200 | 1.09 | 338 |
| Exp. 12 | ES757 | 25.0 | — | 60.0 | 5.2 | 12.4 | 39.9 | 76.0 | 2900 | 1.05 | 318 |
| Cf. 1 | — | 12.0 | — | — | 7.4 | 16.1 | 55.0 | 70.0 | 4700 | 1.25 | 185 |
| Cf. 2 | ES70Y | 110 | — | 10.0 | 7.0 | 12.8 | 47.0 | 20.0 | 500 | 1.38 | 134 |

1. Process for preparing an olefin polymerization catalyst component, said process comprising reacting a carrier compound with a titanium compound, wherein the carrier compound is produced by reacting metallic magnesium with an organic acid ester compound, an organic halide RX, in which X is a halogen and R is an alkyl-, aryl- or cycloalkyl-radical containing a number of carbon atoms in the range of from 1 to 20, and an inorganic metal oxide, said inorganic metal oxide having an average particle size in the range of 0.01 to 100 micrometer (μm).

2. Process according to claim 1, wherein the inorganic metal oxide has an average particle size of from 0.1 to 90 μm.

3. Process according to claim 1, wherein the inorganic metal oxide has an average pore volume of from 0.1 to 10 ml/g.

4. Process according to claim 1, wherein the inorganic metal oxide has a specific surface area in the range of from 10 to 1000 m²/g.

5. (canceled)

6. Process according to claim 1, wherein the inorganic metal oxide comprises silica gel, aluminum oxide, hydrotalcite, mesoporous materials or aluminosilicate.

7. Process according to claim 1, wherein the inorganic metal oxide is partially or fully modified prior to the reaction.

8. Process according to claim 1, wherein the inorganic metal oxide is treated prior to its reaction with the metallic magnesium, the organic acid ester compound and the organic halide RX under oxidizing or non-oxidizing conditions at a temperature in the range of from 100 to 1000° C., in the presence or in the absence of a fluorinating agent.

9. Process according to claim 1, wherein the inorganic metal oxide is dried prior to its reaction with the metallic magnesium, the organic acid ester compound and the organic halide RX under reduced pressure over a time period of from 1 to 10 hours at a temperature of from 100 to 800° C.

10. (canceled)

11. Process according to claim 1, wherein the organic acid ester compound is selected from silicic acid esters having the formula, XₘSi(OR)₄₋ₘ, of and carbon acid esters having the formula RₘC(OR)₄₋ₘ, where R is an alkyl, aryl or cycloalkyl radical containing 1 to 20 carbon atoms, X is halogen or hydrogen or an alkyl, aryl or cycloalkyl radical containing 1 to 20 carbon atoms, and m is an integer from 0 to 3.

12. Process according to claim 1, wherein the organic acid ester compound is employed in an amount such that the ratio between OR groups and gram atoms of Mg is higher than 1.

13. (canceled)

14. Process according to claim 1, wherein the organic halide RX is employed in an amount such that the ratio between X groups and gram atoms of Mg is equal to or higher than 1.

15. Process according to claim 1, wherein the reaction to produce the carrier compound is carried out at temperatures ranging from 20 to 250° C.

16. Process according to claim 1, wherein the organic halide RX is added into a mixture of the metallic magnesium, inorganic metal oxide and organic acid ester compound.

17. Process according to claim 1, wherein the reaction to produce the carrier compound is carried out in the presence of a polar solvent or a mixture of a polar solvent with a hydrocarbon.

18. (canceled)

19. Process according to claim 1, wherein the reaction to produce the carrier compound is carried out in the presence of a promoter or a halogenated hydrocarbon.

20. Process according to claim 1, wherein the catalyst component is obtained by reacting the carrier compound with a titanium compound selected from the group consisting of titanium halides, titanium alkoxides, aryloxytitanium halides, and mixtures thereof.

21. (canceled)

22. Process according to claim 1, wherein the reaction of the carrier compound with the titanium compound is conducted using the liquid titanium compound as a reaction medium.

23. Process according to claim 1, wherein the reaction of the carrier compound with the titanium compound is conducted in the presence of an inert medium that is liquid at the reaction temperature.

24. (canceled)

25. A method of preparing a catalyst system, said method comprising combining a catalyst compound made by the process of claim 1 with an alkyl aluminum compound.

26. A catalyst system for the gas-phase polymerization of 1-olefins comprising a catalyst compound prepared by the process of claim 1 and a co-catalyst comprising an alkyl aluminium compound selected from the group consisting of trialkyl aluminum compounds, alkyl aluminum halides, and mixtures thereof.

27. (canceled)
